(19) United States
(12) Patent Application Publication
(10) Pub. No.: US 2006/0250763 A1
(43) Pub. Date: Nov. 9, 2006

(54) Computer case with attractive appearance and utilization thereof

(75) Inventor: Ronny Ma, Walnut, CA (US)

Correspondence Address: TROXELL LAW OFFICE PLLC, 5205 LEESBURG PIKE, SUITE 1404, FALLS CHURCH, VA, 22041, US

(73) Assignee: Dynapower USA

(21) Appl. No.: 11/124,241

(22) Filed: May 9, 2005

(51) Int. Cl. G06F 1/16

(52) U.S. Cl. 361/683

(57) ABSTRACT

By image layers applied on the outside surfaces, a computer case, a monitor and a keyboard are made more attractive and the outside surfaces of the computer case, the monitor and the keyboard can be further protected.

### FIELD OF THE INVENTION

The present invention relates to the appearance of a computer; more particulary, relates to an image layer that makes the appearance of the computer be more attractive and be further protected.

### DESCRIPTION OF THE RELATED ART

A case of a computer according to a prior art is generally made of a metal, and the outside surface of the computer case is coated in a way of a spray paint or a roast paint to be applied with some colors on its outside surface. The monitor of the computer is made of a display device hold with a plastic shell. The keyboard of the computer is also made of plastic with keys printed with some characters on it, like some numbers, alphabets, etc.

Although the case of the computer according to the prior art can be applied with some colors to have some variations on the appearance, the case of the computer is generally shaped as a cube and is generally colored in white or black So, its appearance and its color look monotonous with no variation. Furthermore, the case of the computer is applied with some colors only; so, when moving or deposing the main frame of the computer, the color of the computer case may be lost owing to accidental collisions or crashes. In addition, the monitor is only made of a display device hold with a plastic shell and its keyboard is also made of a plastic, which makes the appearances of them are of the original color of the plastic, so that the appearances and the colors of the monitor and the keyboard also look monotonous with no variation. Accordingly, the computer case of the prior art does not fulfill users' requests.

### SUMMARY OF THE INVENTION

Therefore, the main purpose of the present invention is, through setting up an image layer, to make a computer main frame case, a monitor and a keyboard be more attractive; and to protect the outside surface of the computer case, the monitor and the keyboard.

To achieve the above purpose, the present invention is a computer case with attractive appearance and utilization thereof, comprising an image layer deposed at the outside surface of the computer main frame case, the monitor and the keyboard. A plurality of image layers are deposed on the front end surface, the top end surface, the right end surface and the left end surface of the computer main frame case, on the outside surface of the plastic shell of the monitor, and on the whole surface of the keyboard.

### BRIEF DESCRIPTIONS OF THE DRAWINGS

The present invention will be better understood from the following detailed descriptions of the preferred embodiments according to the present invention, taken in conjunction with the accompanying drawings, in which

FIG. 1 is an exploded view of the structure according to the present invention;

FIG. 2 is a perspective view of a first embodiment according to the present invention;

FIG. 3 is a perspective view of a second embodiment according to the present invention; and

FIG. 4 is a perspective view of a third embodiment according to the present invention;

### DESCRIPTION OF THE PREFERRED EMBODIMENTS

The following descriptions of the preferred embodiments are provided to understand the features and the structures of the present invention.

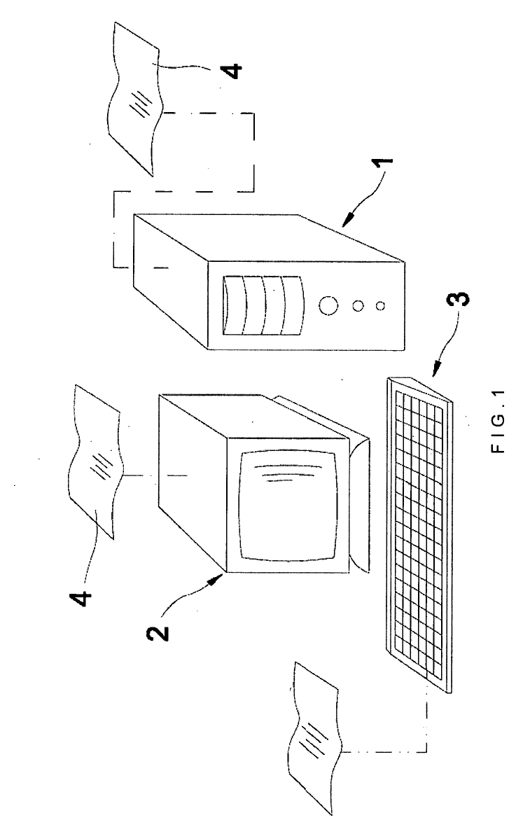

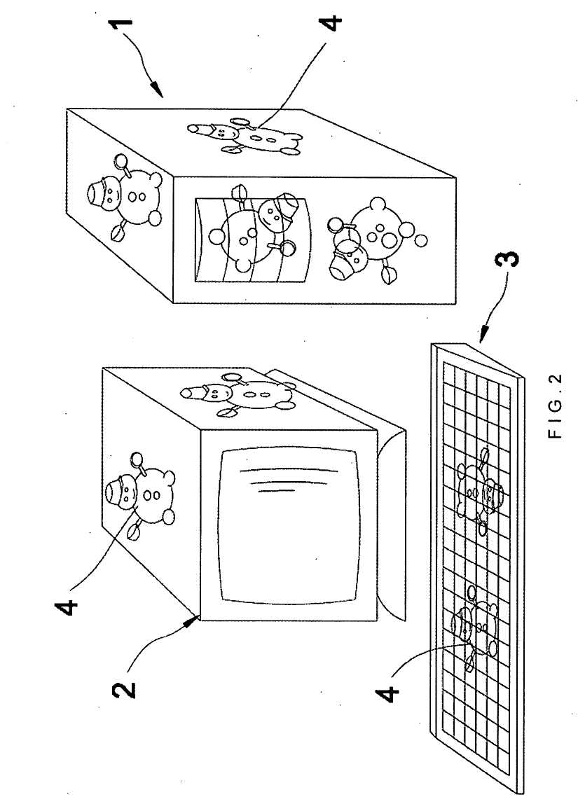

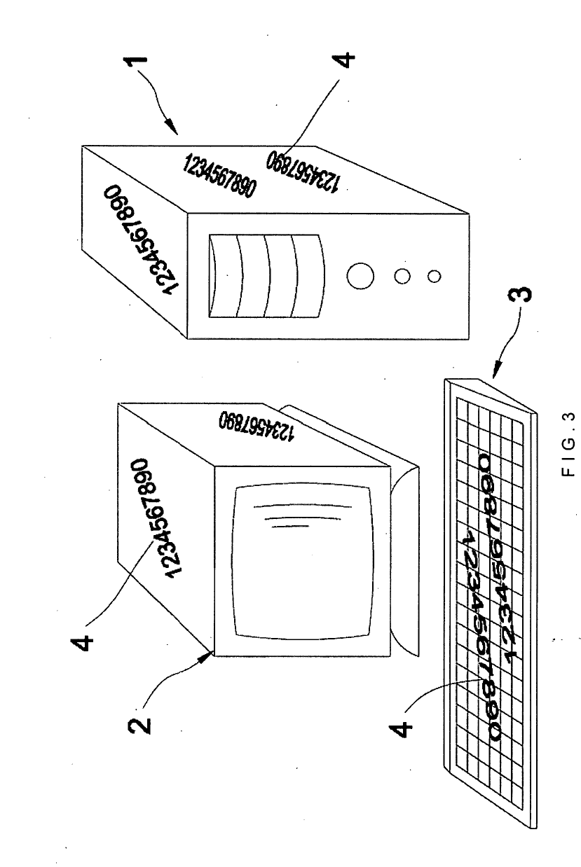

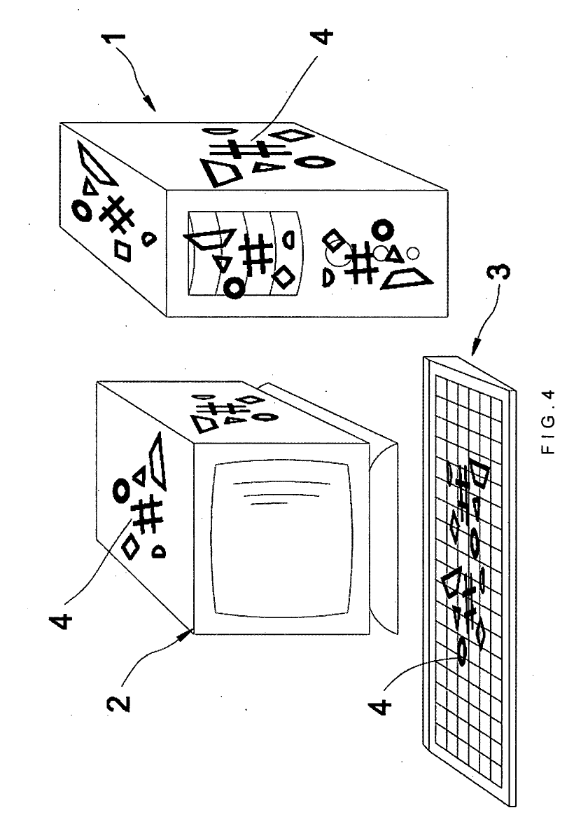

Please refer to FIG. 1 through FIG. 4, which are an exploded view of the structure and perspective views of a first, a second and a third embodiments, according to the present invention. As shown in the figures, the present invention is a computer case with attractive appearance and utilization thereof, comprising an image layer 4, which are deposed on outside surfaces of a computer main frame case 1, a monitor 2 and a keyboard 3, where the image layers 4 wrap at least on a front end surface, a top end surface, a right end surface and a left end surface of the computer main frame case 1, on a surface of a plastic shell of the monitor 2, and on a whole surface of the keyboard 3. The image layer 4 can be deposed on outside surfaces of the computer main frame case 1, the monitor 2 and the keyboard 3 in a way of a heating transfer printing, a water transfer printing or a handicraft drawing under different pressure. The image layer 4 can be a pattern of animal images (as shown in FIG. 2), characters (as shown in FIG. 3) or geometric figures (as shown in FIG. 4). In this way, a novel computer case with attractive appear-an ce and utilization thereof is formed that the appearances of the computer case, the monitor and the keyboard can be more attractive and be further protected on the outside surfaces.

When the image layer 4 according to the present invention is deposed on the outside surfaces of the computer main frame case 1, the monitor 2 or the keyboard 3 by way of a heating transfer printing, an image of animals, characters or geometric figures is printed on a heatproof adhesive paper and then the image of animals, characters or geometric figures is transferred on the computer main frame case 1, on the monitor 2 or on the keyboard 3 through heating and pressing. Even a pattern with various colors can be printed on the computer main frame case 1, on the monitor 2 or on the keyboard 3 in this way.

Nevertheless, when the image layer 4 according to the present invention is deposed on the outside surfaces of the computer main frame case 1, the monitor 2 or the keyboard 3 by way of a water transfer printing, an image of animals, characters or geometric figures is printed on an aqueous film, which can be easily hydrolyzed, to be an image layer. Because a water-covering film is of high tensility, it can be easily wrapped on a computer main frame case 1, a monitor 2 and a keyboard 3 to form an image layer 4 so that the computer main frame case 1 the monitor 2 and the keyboard 3 can have a totally different appearance like being spray-painted. This kind of technique of a water transfer printing can make an image layer 4 be covered on any shapes of a computer main frame case 1, a monitor 2 and a keyboard 3.

To sum up, the present invention of a computer case with attractive appearance and utilization thereof can make a computer case, a monitor and a keyboard more attractive and the outside surfaces of the computer case, the monitor and the keyboard can be further protected.

The preferred embodiments herein disclosed are not intended to unnecessarily limit the scope of the invention. Therefore, simple modifications or variations belonging to the equivalent of the scope of the claims and the instructions disclosed herein for a patent are all within the scope of the present invention.

What is claimed is:

1. A computer case with attractive appearance and utilization thereof, comprising an image layer, wherein said image layers are deposed
on a front end surface, a top end surface, a right end surface and a left end surface of a computer main frame case,
on a surface of a plastic shell of a monitor, and
on a whole surface of a keyboard.

2. The computer case with attractive appearance and utilization thereof according to claim 1, wherein said image layer is transferred to said main frame case, said monitor and said keyboard by a heating transfer printing.

3. The computer case with attractive appearance and utilization thereof according to claim 1, wherein said image layer is transferred to said main frame case, said monitor and said keyboard by a water transfer printing.

4. The computer case with attractive appearance and utilization thereof according to claim 1, wherein images of said image layer is drawn on said main frame case, said monitor and said keyboard as a handicraft image.

5. The computer case with attractive appearance and utilization thereof according to claim 1, wherein said image layer is an image of animals.

6. The computer case with attractive appearance and utilization thereof according to claim 1, wherein said image layer is an image of characters.

7. The computer case with attractive appearance and utilization thereof according to claim 1, wherein said image layer is an image of geometric figures.
